(19) United States
(12) Patent Application Publication
(10) Pub. No.: US 2008/0143659 A1
(43) Pub. Date: Jun. 19, 2008

(54) LCD driving methods

(75) Inventor: Won Seok Ma, Seongnam-Si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/981,241

(22) Filed: Oct. 30, 2007

(30) Foreign Application Priority Data
Dec. 15, 2006 (KR) 10-2006-0128730

(51) Int. Cl. G09G 3/36

(52) U.S. Cl. 345/87

(57) ABSTRACT

A method for driving a display device includes sequentially applying a gate turn-on voltage to respective gate lines of the device during successive image display periods thereof, applying a respective one of a plurality of successive data signals, each corresponding to a respective one of the gate lines, to a plurality of data lines of the device while the gate turn-on voltage is being applied to the corresponding gate line, applying the gate turn-on voltage to all of the of gate lines of the device during successive vertical blanking periods of the device that alternate with the image display periods, and applying a dummy data signal to the data lines while the turn-on voltage is being applied to the gate lines. The dummy data signal forcibly discharges any residual charges in the pixel storage capacitors to prevent the occurrence of residual images in the display.

### RELATED APPLICATIONS

This application claims priority of Korean Patent Application No. 2006-0128730, filed Dec. 15, 2006, the entire disclosure of which is incorporated herein by reference.

### BACKGROUND

The present disclosure generally relates to display devices, such as liquid crystal displays (LCDs), and more particularly, to methods for driving LCDs in such a way as to prevent the occurrence of residual image defects therein caused by residual charges in the pixel storage capacitors thereof.

LCDs incorporate a plurality of pixels, each of which is operative to change an electric field acting on a layer of liquid crystal material therein so as to display images by controlling the alignment of the molecules of the liquid crystal material and thereby adjusting the transmittance of light passing through the pixel. Each pixel includes storage capacitors that are used to maintain the electric field acting on the liquid crystal material for a predetermined period of time after the formation of the field. However, the prior art technique for independently wiring the storage capacitors involves one terminal of each of the storage capacitors being connected to a common power supply. This can result in a problem, in that the charges stored in the storage capacitors may not be completely discharged between frames, thereby leaving residual charges remaining in the capacitors and giving rise to the occurrence of undesirable residual images in the display.

### BRIEF SUMMARY

In accordance with the exemplary embodiments described herein, LCDs and methods for driving them are disclosed that prevent the occurrence of residual images in the displays due to residual charges in pixel storage capacitors by applying a dummy gate signal and a dummy data signal after the completion of one frame signal, which are effective to completely discharge the residual charges in the pixel storage capacitors.

In one exemplary embodiment, a method of driving an LCD includes sequentially applying a gate turn-on voltage to respective ones of a plurality of gate lines of the device during successive image display periods thereof. A respective one of a plurality of successive data signals, each corresponding to a respective one of the gate lines, is applied to a plurality of data lines of the device while the gate turn-on voltage is being applied to the corresponding gate line. During successive vertical blanking periods of the device that alternate with the image display periods thereof, the gate turn-on voltage is applied to the plurality of gate lines of the device simultaneously, and a dummy data signal is applied to the data lines of the device while the turn-on voltage is being applied to the gate lines thereof.

Each of the vertical blanking periods may be longer than a period during which the gate turn-on voltage is applied to respective ones of the gate lines and shorter than the image display periods. The image display periods may occur at a rate of 24 to 120 per second. The plurality of data signals may be inversely driven.

When the number of the gate lines of the device is odd, an odd-number of dummy data signals may be applied during each of the vertical blanking periods. When the number of the gate lines of the device is even, an even-number of dummy data signals may be applied during each of the vertical blanking periods.

A signal that corresponds to a maximum or a minimum pixel grayscale value may be used as the dummy data signal.

The gate turn-on voltage may be simultaneously applied to the plurality of gate lines during each of the vertical blanking periods.

In another exemplary embodiment, a display device comprises an LCD panel that includes a plurality of gate lines and a plurality of data lines, a gate driver connected to the gate lines and selectably operative to sequentially apply a gate turn-on voltage to respective ones of the gate lines or to simultaneously apply the gate turn-on voltage to the plurality of gate lines, and a data driver connected to the plurality of data lines and selectably operative to apply a respective one of a plurality of successive data signals, each corresponding to a respective one of the gate lines, to the data lines of the device while the gate turn-on voltage is being applied to the corresponding gate line, or to supply a dummy data signal to all of the data lines of the device while the turn-on voltage is being applied to all of the gate lines thereof.

The gate driver may includes a plurality of stages that sequentially supply the gate turn-on voltage to respective ones of the plurality of gate lines and a discharge controller disposed between the plurality of stages and the plurality of gate lines and operative to supply the gate turn-on voltage to respective ones of the plurality of gate lines in response to an external control signal.

The discharge controller may comprise a plurality of OR gates or exclusive OR gates respectively connected to corresponding ones of the gate lines.

The LCD panel may further include pluralities of thin film transistors, pixel capacitors and storage capacitors respectively disposed at intersections of the gate lines and the data lines, and one electrode terminal of each of an associated pair of the pixel and storage capacitors may be connected to an associated one of the thin film transistors, with the other electrode terminal thereof being connected to a common power supply.

A better understanding of the above and many other features and advantages of the novel LCDs and methods for driving them of the present invention, may be obtained from a consideration of the detailed description of some exemplary embodiments thereof below, particularly if such consideration is made in conjunction with the appended drawings, wherein like reference numerals are used to identify like elements illustrated in one or more of the figures thereof.

### BRIEF DESCRIPTION OF THE DRAWINGS

FIG. 1 is a conceptual schematic and functional block diagram of a first exemplary embodiment of an LCD in accordance with the present invention;

FIG. 2 is a signal waveform diagram illustrating the operation of the first exemplary LCD of FIG. 1;

FIG. 3 is a signal waveform diagram illustrating the operation of the exemplary LCD of FIG. 1 in terms of the number of the gate lines thereof;

FIG. 4 is another signal waveform diagram illustrating the operation of the exemplary LCD of FIG. 1 in terms of the number of the gate lines thereof;

FIG. 5 is a conceptual schematic and functional block diagram of a second exemplary embodiment of an LCD in accordance with the present invention; and,

FIG. 6 is a signal waveform diagram illustrating the operation of the second exemplary LCD of FIG. 5.

### DETAILED DESCRIPTION

Exemplary embodiments of the invention are described in detail below with reference to the accompanying drawings. However, it should be understood that the invention may be embodied in many different forms, and accordingly, should not be constructed as being limited to the particular exemplary embodiments set forth herein. Rather, these exemplary embodiments are provided so that this disclosure will be thorough and complete and will fully convey the concept of the invention to those skilled in the art.

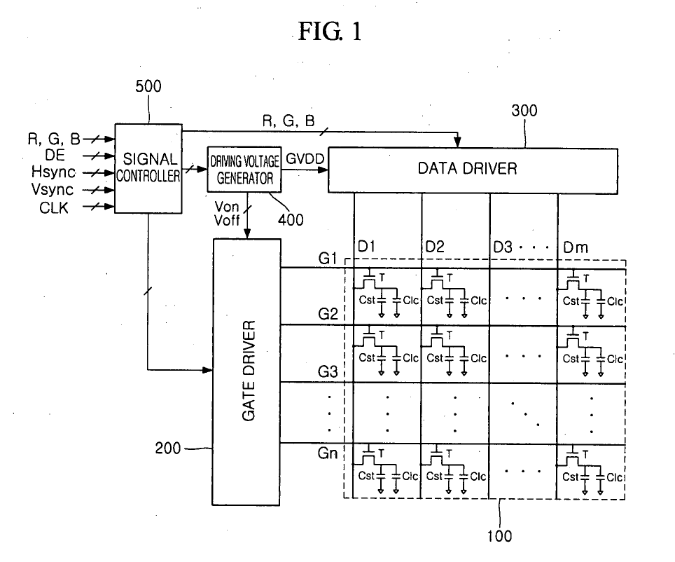

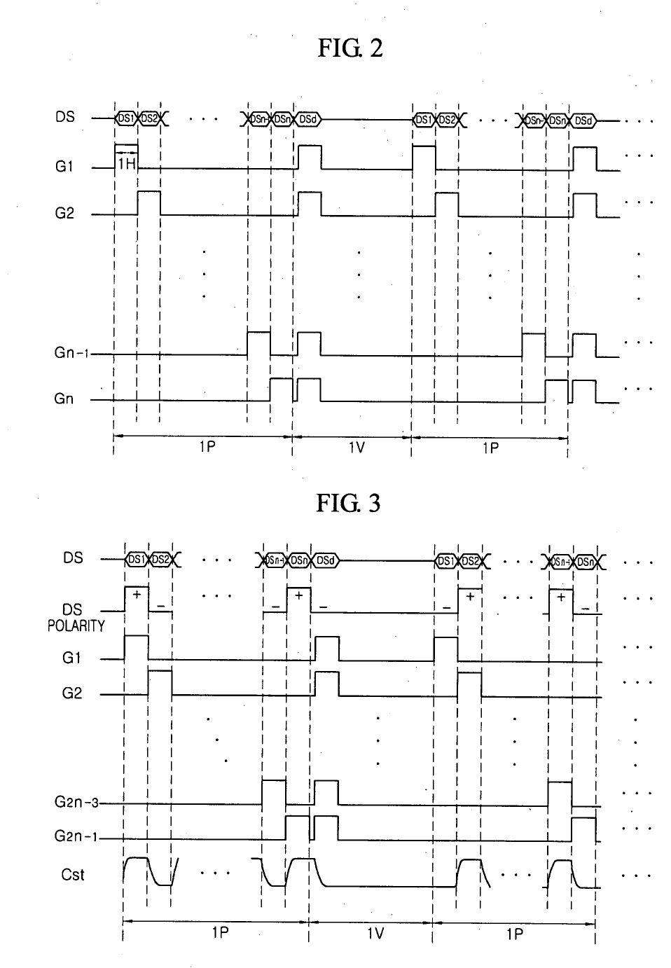

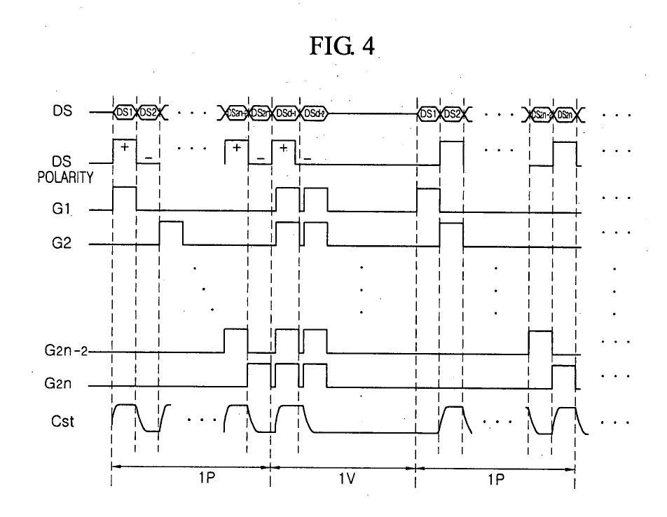

FIG. 1 is a conceptual schematic and functional block diagram of a first exemplary embodiment of a liquid crystal display (LCD) in accordance with the present invention. FIG. 2 is a signal waveform diagram illustrating the operation of the first exemplary LCD of FIG. 1. FIGS. 3 and 4 are signal waveform diagrams illustrating the operation of the first exemplary LCD in terms of the number of the gate lines thereof;

Referring to FIGS. 1 to 4, the first exemplary LCD includes an LCD panel 100, a gate driver 200, a data driver 300, a driving voltage generator 400, and a signal controller 500.

The LCD panel 100 includes a plurality of gate lines G1 to Gn that extend generally in a row or latitudinal direction in FIG. 1, a plurality of data lines D1 to Dm that extend generally in a column or longitudinal direction, and which are therefore disposed generally orthogonal to the plurality of gate lines G1 to Gn, and a plurality of pixels that are respectively disposed at intersections of the gate lines G1 to Gn and the data lines D1 to Dm.

Each of the pixels includes a thin film transistor T, a storage capacitor Cst, and a pixel capacitor Clc. The pixels comprise red (R), green (G) and blue (B) pixels, which can be combined appropriately with each other to enable the panel to display images of a myriad of colors. The LCD panel 100 also includes a thin film transistor (TFT) substrate (not illustrated) on which the thin film transistors T, the gate lines G1 to Gn, the data lines D1 to Dm, the pixel electrodes, and the storage electrodes are formed, as well as a common electrode substrate (not illustrated) on which a black matrix, color filters, and a common electrode are formed. A layer of a liquid crystal material (not illustrated) is disposed between the thin film transistor substrate and the common electrode substrate. Each storage capacitor Cst and associated pixel capacitor Clc share an associated pixel electrode.

In the particular exemplary embodiment illustrated in FIG. 1, the thin film transistors T have gate terminals that are connected to respective ones of the gate lines G1 to Gn, source terminals that are connected to respective ones of the data lines D1 to Dm, and drain terminals that are connected to respective ones of the pixel electrodes. In this way, the thin film transistors T operate in response to a gate turn-on voltage applied to the associated gate lines G1 and Gn to supply respective data signals (i.e., gray voltages) from the data lines D1 to Dm to the associated pixel electrodes, each of which is used as one electrode terminal of the associated pixel capacitor Clc and associated storage capacitor Cst, so as to change an electric field at both ends of each of the pixel and storage capacitors Clc and Cst. As a result, the arrangement of liquid crystal molecules inside each pixel of the LCD panel 100 is changed, such that it is possible to individually adjust the transmittance of light supplied by a backlight and passing through each pixel. A plurality of cutout and/or protrusion patterns may be provided on the pixel electrode as a domain controlling mechanism that controls the direction in which the liquid crystal molecules is aligned locally, and protrusion and/or cutout patterns may also be provided on the common electrode. In the particular exemplary embodiment under discussion, i.e., a “vertically aligned” display, the molecules of the liquid crystal material are preferably aligned vertically with respect to the substrates of the panel, but it should be understood that the present invention is not limited thereto.

A controller is provided externally of the LCD panel 100 for supplying signals that drive the LCD panel 100. The controller includes a gate driver 200, a data driver 300, a driving voltage generator 400, and a signal controller 500.

The gate driver 200 and/or the data driver 300 may be mounted on the thin film transistor substrate of the LCD panel 100, or may be mounted on a separate printed circuit board (PCB) and then electrically connected to the LCD panel 100 through a flexible printed circuit board (FPC). In one exemplary preferred embodiment, the gate driver 200 and the data driver 300 are incorporated in a single driving chip, and the driving voltage generator 400 and the signal controller 500 are both mounted on a separate printed circuit board and electrically connected to the LCD panel 100 through an FPC board.

The signal controller 500 receives an input image signal from an external graphic controller (not illustrated), that is, pixel red, green and blue (RGB) data, and an input control signal for controlling the pixel RGB data, for example, a vertical synchronization signal Vsync, a horizontal synchronization signal Hsync, a main clock CLK, and a data enable signal DE. The signal controller 500 processes the pixel data according to the operating conditions of the LCD panel 100, generates a gate control signal and a data control signal, and transmits the gate control signal to the gate driver 200. The pixel data is rearranged to correspond to the particular arrangement of the pixels of the LCD panel 100. The gate control signal includes a vertical synchronization start signal that instructs the start of the output of the gate turn-on voltage Von, a gate clock signal, an output enable signal, and the like. Of importance herein, the gate control signal further includes a gate open signal that applies the gate turn-on voltage to all of the gate lines.

The data control signal includes a horizontal synchronization start signal that informs of the start of transmission of the pixel data, a load signal that instructs the application of a data voltage to a corresponding data line, an inversion signal that inverts the polarity of a gray voltage with respect to the common voltage, a data clock signal, and the like. Of importance herein, the data control signal further includes a dummy control signal that instructs the output of a dummy data signal.

The driving voltage generator 400 generates the various driving voltages needed to drive the LCD using external power input from an external power supply (not illustrated). The driving voltage generator 400 generates a reference voltage GVDD, a gate turn-on voltage Von, a gate turn-off voltage Voff, and a common voltage. The driving voltage generator 400 supplies the gate turn-on voltage Von and the gate turn-off voltage Voff to the gate driver 200 in accordance with a control signal from the signal controller 500, and supplies the reference voltage GVDD to the data driver 300. In the particular exemplary embodiment of FIG. 1, the reference voltage GVDD is used as a reference voltage for generating the gray voltages that drive the molecules of the liquid crystal material in the manner described above.

The gate driver 200 applies the gate turn-on/turn-off voltages Von/Voff of the driving voltage generator 400 to respective ones of the gate lines G1 to Gn in accordance with the external control signal. In this way, it is possible to control each of the corresponding thin film transistors T of a given row of pixels such that the gray voltages that are to be respectively applied to each of the pixels in that row is applied to the corresponding pixels thereof. Thus, during one image display period 1P, the gate driver 200 sequentially applies the gate turn-on voltage Von to each of the plurality of gate lines G1 to Gn of the panel.

In addition to the foregoing operation, the gate driver 200 also applies the gate turn-on voltage Von to all of the plurality of gate lines G1 to Gn, either sequentially or simultaneously, at least once during a “vertical blanking period” 1V. The vertical blanking period 1V refers to a period between the point in time at which one image display period 1P ends and that at which the next image display period 1P begins. That is, as illustrated in FIG. 2, the vertical blanking period 1V refers to a period beginning after the gate turn-on voltage Von is applied to the last gate line Gn in order to display the last line of a given image frame and immediately before the gate turn-on voltage Von is applied again to the first gate line G1 to display the next image frame.

As used herein, the image display period 1P refers to the time period during which one image frame is displayed. Thus, during one image display period 1P, data signals are supplied to all of the pixel and storage capacitors Cst of the LCD panel 100. The image display period 1P may vary in accordance with the number of gate lines G1 to Gn of the panel and the time during which the gate turn-on voltage Von is supplied to each of the gate lines G1 to Gn thereof. That is, if the time during which the gate turn-on voltage V1 is supplied to each one of the gate lines G1 to Gn is 1H, and the number of gate lines G1 to Gn is n, then the image display period 1P is equal to 1H×n. Additionally, as is known, a moving picture can be generated by rapidly displaying a sequence of images during consecutive ones of the image display periods 1P. Accordingly, each of the exemplary LCDs described herein preferably are capable of producing 24 to 120 image display periods 1P per second. As used herein, one image display period 1P may correspond to one frame frequency IF, or alternatively, one image display period 1P and one vertical blanking period 1V may correspond to one frame frequency IF. Preferably, the vertical blanking period 1V is longer than the time 1H during which the gate turn-on voltage Von is applied to each of the gate lines G1 to Gn, and is shorter than the image display period 1P, i.e., 1H<1V<1P. When the vertical blanking period 1V is shorter than the time period 1H, it is difficult to supply the gate turn-on voltage Von to all of the gate lines G1 to Gn simultaneously, and when the vertical blanking period 1V is larger than the image display period 1P, it is difficult to display an image smoothly.

The data driver 300 generates gray voltages (i.e., data signals) by using a control signal of the signal controller 500 and the reference voltage GVDD of the driving voltage generator 400, and applies the generated gray voltages to respective ones of the data lines D1 to Dm. That is, the data driver 300 converts the pixel data that is input in a digital format into a sequence of data signals DS1 to DSn that are output in an analog format using the reference voltage GVDD. Additionally, the data driver 300 generates a dummy data signal DSd in an analog format in accordance with an external control signal, as described in more detail below.

The data driver 300 generates a plurality of gray voltages using the reference voltage GVDD. Further, during one image display period 1P, the data driver 300 changes the digital format of the pixel data supplied from the signal controller 500 into the analog format data signals DS1 to DSm using the gray voltages, and then outputs the resulting sequence of analog data signals DS1 to DSm to the corresponding data lines D1 to Dm, respectively. Accordingly, as shown in FIG. 2, the first data signal DS1 is respectively applied to the first through m-th data lines D1-Dm while the first gate line G1 is “on,” i.e., while Von is being applied to the first gate line G1, the second data signal DS2 is respectively applied to the data lines D1-DM while the second gate line G2 is on, the n-1-th data signal DSn-1 is respectively applied to the data lines D1-Dm while the n-1-th gate line Gn-1 is on, and the n-th data signal DSm is respectively applied to the data lines D1-Dm while the n-th gate line Gn is on. Additionally, it is preferable that the data signals applied to each of the data lines D1-Dm during one frame has a polarity that is opposite to the polarity of the data signal applied to that data line in the preceding frame. That is, if a first data signal applied to a given data line during a first frame has a positive polarity, it is preferable that the second data signal applied to that data line have a negative polarity during the next frame.

The data driver 300 also generates the dummy data signal DSd described above at least once during the vertical blanking period 1V using the gray voltages, and applies it to all of the data lines D1-Dm, either sequentially or simultaneously, during that period. Thus, during the vertical blanking period 1V, the data driver 300 applies the dummy data signal DSd, which is a signal that discharges the residual charges in the storage capacitors Cst of the pixels of the LCD panel 100, to the data lines D1-Dm so as to prevent residual images from occurring in the panel due to the residual charges. That is, the data driver 300 generates the dummy data signal DSd that prevents the charging of the capacitors Cst and supplies the generated dummy data signal DSd to the plurality of data lines D1 to Dm during the vertical blanking period 1V and while the gate turn-on voltage is being applied to the respective gate lines G1-Gn.

It is preferable that the dummy data signal DSd have either the maximum value or the minimum value of a pixel gray voltage, which may vary according to the particular liquid crystal mode used in the display panel. That is, when the liquid crystal mode used in the LCD panel 100 is a “normally white” mode, the data driver 300 generates a dummy data signal DSd corresponding to a normally white mode and applies it to the plurality of data lines D1 to Dm during the vertical blanking period 1V. Conversely, when the liquid crystal mode of the display is a “normally black” mode, the data driver 300 generates a dummy data signal DSd corresponding to a normally black mode and applies the dummy data signal DSd to the plurality of data lines D1 to Dm. As a result of the application of the dummy data signal DSd, the LCD panel 100 will exhibit either a white or a black display after the application of the dummy signal. However, since the vertical blanking period 1V is very short, a user does not recognize the displayed color as a residual image. Thus, the dummy data signal DSd is applied such that the charges remaining in the storage capacitors Cst are forcibly discharged and the occurrence of residual images is thereby prevented. Of course, as discussed above, it is preferable that the dummy signal DSd applied to each of the data lines D1-Dm during the vertical blanking period 1V has a polarity that is opposite to the polarity of the data signal that was applied to that data line in the preceding frame. That is, if a first data signal applied to a given data line during a first frame has a positive polarity, it is preferable that the dummy data signal applied to that data line have a negative polarity during the succeeding vertical blanking period, and so on, in an alternating fashion.

Referring to the waveform diagram of FIG. 2, the operation of the exemplary display device of FIG. 1 is as follows.

The display device operates for a plurality of successive image display periods 1P and vertical blanking periods 1V that alternate with each other. The display device displays an image through the LCD panel 100 during each image display period 1P, and during the vertical blanking period 1V, the display device synchronizes a plurality of control signals and discharges the residual charges of the storage capacitors Cst of the LCD panel 100.

During the image display period 1P, the gate driver 200 of the display device sequentially applies a gate turn-on voltage Von to each of the plurality of gate lines G1 to Gn, and the data driver 300 supplies the sequence of data signals DS1 to DSn to the plurality of data lines D1 to Dm in coordination therewith. During the vertical blanking period 1V, the gate driver 200 of the display device applies the gate turn-on voltage Von to all of the plurality of gate lines G1 to Gn, sequentially or simultaneously, and the data driver 300 supplies the dummy data signal DSd to the plurality of data lines D1 to Dm.

Thus, as illustrated in FIG. 2, during one image display period 1P, the gate turn-on voltage Von is sequentially applied to the first to n-th gate lines G1 to Gn, and the rows of thin film transistors T that are respectively connected to the gate lines G1 to Gn are thereby respectively turned on. Synchronously with the foregoing, the first to n-th data signals DS1 to DSn are successively applied to the data lines D1 to Dm, and accordingly, are respectively supplied to the pixel capacitors Clc and the storage capacitors Cst that are respectively connected to the rows of thin film transistors T that are respectively turned on.

More specifically, when the gate turn-on voltage Von is applied to the first gate line G1 and the first data signal DS1 corresponding to gate line G1 is applied to the plurality of data lines D1 to Dm, the plurality of thin film transistors T that are connected to the first gate line G1 are turned on in response to the gate turn-on voltage Von, and the first data signal DS1 is supplied to the plurality of pixel capacitors Clc and the storage capacitors Cst that are respectively connected to the turned on thin film transistors T through those transistors T. The gate turn-on voltage Von is then sequentially applied to the second to the n-th gate lines G2 to Gn, and accordingly, the second to n-th data signals DS2 to DSn are successively applied to the plurality of data lines D1 to Dm. Therefore, the second to n-th data signals DS2 and DSn are respectively supplied to all of the respective pixel capacitors Clc and the storage capacitors Cst of the LCD panel 100. As a result, the alignment of the liquid crystal molecules in the pixel capacitors Clc is changed in accordance with the data signals DS1 to DSn that are applied to the pixel capacitors Clc, such that the transmittance of light passing through the liquid crystal material of each pixel is selectively controlled and an image is displayed. Here, when the gate turn-on voltage Von is applied to one of the gate lines G1 to Gn, the gate turn-off voltage Voff is applied to the other gate lines G1 to Gn. Further, it is preferable that for the first to the n-th data signals DS1 to DSn, voltages for odd-numbered data signals and even-numbered data signals have opposite polarities. That is, the LCD panel 100 performs a “line inversion.” The gate turn-on voltage Von is preferably supplied to the first to the n-th gate lines G1 to Gn in accordance with a gate clock signal (not illustrated) of the signal controller 500. The gate turn-on voltage Von is preferably supplied during the time 1H.

Also as illustrated in FIG. 2, the gate turn-on voltage Von is simultaneously applied to the first to the n-th gate lines G1 to Gn during the vertical blanking period 1V, such that all of the thin film transistors T inside the LCD panel 100 are turned on. During this period, the dummy data signal DSd is applied to the data lines D1 to Dm, and supplied to all of the pixel capacitors Clc and the storage capacitors Cst of the LCD panel 100 by the thin film transistors T that are turned on. As a result, the residual charges in the storage capacitors Cst inside the LCD panel 100 are completely discharged, and thus, the occurrence of residual images due to the residual charges is prevented. As discussed above, a signal corresponding to the normally white mode or a signal corresponding to the normally black mode may be used as the dummy data signal DSd, depending on the liquid crystal mode being used in the display. That is, a signal that is capable of returning the molecules of the liquid crystal material from an alignment used to display an image during the preceding frame to an initial alignment corresponding to either a black or a white display is preferably used as the dummy data signal DSd.

The gate turn-on voltage Von and the dummy data signal DSd may be supplied at the time the vertical blanking period 1V starts, or alternatively, may be supplied at any time during the vertical blanking period 1V. Further, the length of time during which the gate turn-on voltage Von is supplied is preferably 1H. Of course, the length of time during which the gate turn-on voltage Von is supplied may be made larger than 1H in order to ensure that the dummy data signal DSd is supplied to all of the pixel capacitors Clc and the storage capacitors Cst.

In this particular embodiment, since the LCD panel 100 performs line inversion, the dummy data signal DSd that is supplied during the vertical blanking period 1V may change in accordance with the number of gate lines G1 to Gn of the panel. That is, as illustrated in FIG. 3, when there are an odd-number of gate lines G1 to G2n-1, the gate turn-on voltage Von and the dummy data signal DSd are applied only once. Of course, an odd number of gate turn-on voltages Von and dummy data signals DSd may be supplied. Alternatively, as shown in FIG. 4, when there are an even-number of gate lines G1 to G2n, the gate turn-on voltage Von and the dummy data signal DSd are applied twice. Of course, an even-numbered gate turn-on voltages Von and dummy data signals DSd may also be supplied.

The above relationships vary according to the polarity of the data signal DSn that is finally applied during one image display period 1P. That is, as illustrated in FIG. 3, when there are an odd-number of gate lines G1 to G2n-1, the final data signal DS2n-1 that is applied by actuation of the final gate line G2n-1 has a positive polarity. Hence, the signal that is finally charged in the associated storage capacitors Cst will also have a positive polarity. Therefore, in order for the associated storage capacitors Cst to be empty and have a negative polarity, a dummy data signal DSd having a negative polarity is applied once. Alternatively, as illustrated in FIG. 4, when there are an even-number of gate lines G1 to G2n, the final data signal DS2n that is applied through the final gate line G2n has a negative polarity. Hence, the signal that is finally charged in the associated storage capacitors Cst will also have a negative polarity. In order that the storage capacitors Cst be empty and have a negative polarity, a first dummy data signal DSd-1 having a positive polarity needs to be applied first, and then a second dummy data signal DSd-2 having a negative polarity needs to be applied thereafter.

As described above, all of the respective charges in the storage capacitors Cst are discharged during the vertical blanking period 1V to thereby prevent residual images from occurring in the display. Further, since the charges in the storage capacitors Cst are completely discharged, they do not adversely affect the first to n-th data signals DS1 to DSn that are applied during the next image display period 1P.

It should be understood that the invention is not limited to the particular exemplary embodiments described above, and for example, the image display and vertical blanking periods may be different from those described above in accordance with the number of gate lines. In another example, when a plurality of stages are used as the gate driver, logic gates that sequentially or simultaneously supply a gate turn-on voltage to the gate lines may also be included.

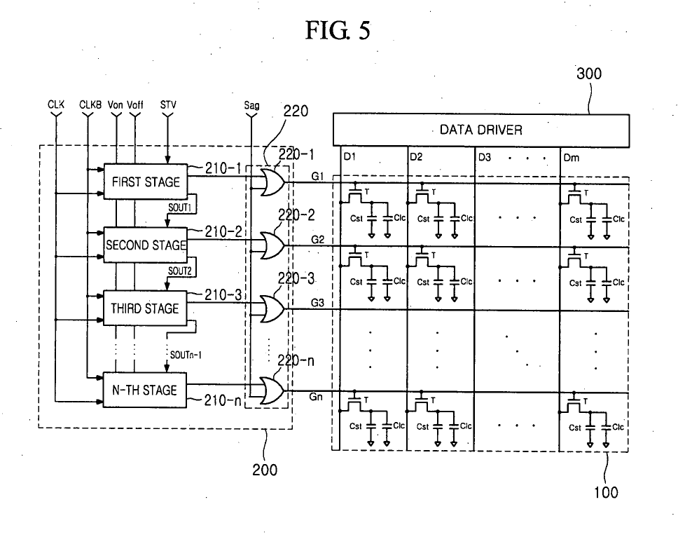

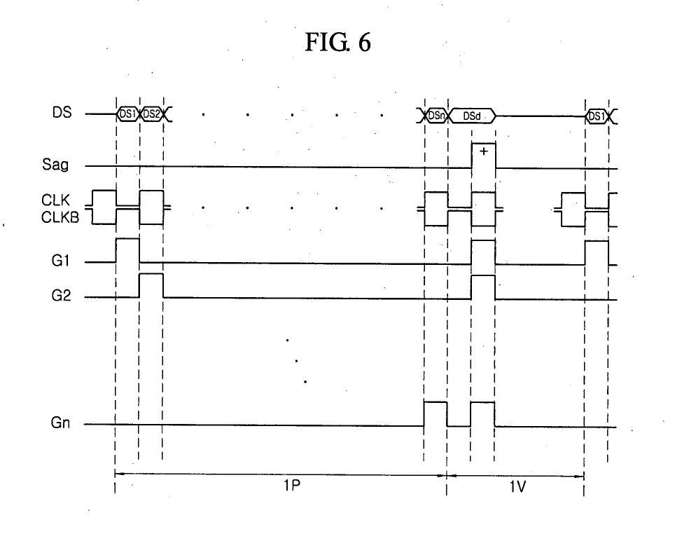

A second exemplary embodiment of an LCD in accordance with the present invention is described below in conjunction with FIGS. 5 and 6. Those portions of the description that overlap the description of the first exemplary embodiment above are omitted for brevity. Additionally, it should be understood that the techniques of the second exemplary LCD described below can be applied to the first exemplary embodiment described above.

FIG. 5 is a conceptual schematic and functional block diagram of the second exemplary LCD, and FIG. 6 is a signal waveform diagram illustrating the operation of the second exemplary LCD of FIG. 5.

Referring to FIGS. 5 and 6, the second exemplary display device includes an LCD panel 100 that has respective pluralities of gate lines G1 to Gn, data lines D1 to Dm, thin film transistors T, pixel capacitors Clc, and storage capacitors Cst disposed thereon, as well as a gate driver 200 that includes a plurality of stages 210-1 to 210-n and a discharge controller 220 that are connected to the plurality of gate lines G1 to Gn, a data driver 300 that is connected to the data lines D1 to Dm, and a signal controller (not illustrated) that controls the foregoing elements.

The gate driver 200 is formed at an edge of one side of a thin film transistor substrate of the LCD panel 100. That is, when the thin film transistor substrate of the LCD panel 100 is manufactured, the gate driver 200 is preferably manufactured together with it.

The gate driver 200 includes the same number of stages 210-1 to 210-n as the number of gate lines G1 to Gn, and the discharge controller 220 includes the same number of logic gates 220-1 to 220-n as the number of gate lines G1 to Gn. That is, respective ones of the stages 210-1 to 210-n and the logic gates 220-1 to 220-n are connected to corresponding ones of the gate lines G1 to Gn, respectively. The stages 210-1 to 210-n operate in response to a vertical synchronization start signal STV or an output of a previous stage, and respectively supply a gate turn-on voltage Von or a gate turn-off voltage Voff to the corresponding logic gates 220-1 to 220-n in the discharge controller 220 using a clock signal CLK or an inverted clock signal CLKB.

The logic gates 220-1 to 220-n operate in response to an external gate voltage control signal Sag. Further, the logic gates 220-1 to 220-n respectively supply the gate turn-on voltage Von or the gate turn-off voltage Voff that are applied from the respective stages 210-1 to 210-n to the gate lines G1 to Gn, or change a level of the gate turn-off voltage Voff and supply the gate turn-on voltage Von to the gate lines G1 to Gn. To this end, as illustrated in FIG. 5, it is preferable that OR gates be used as the logic gates 220-1 to 220-n of the discharge controller 220. Alternatively, exclusive OR gates may be used such that the gate turn-on voltage is simultaneously applied to the gate lines G1 to Gn in the same manner as when OR gates are used. Of course, the logic gates 220-1 to 220-n in the discharge controller 220 are not limited to the foregoing elements, and a variety of other types of switching elements that operate in response to the external gate voltage control signal Sag to supply a separate gate turn-on voltage to the logic gates 220-1 to 220-n may be used instead. In the particular exemplary embodiment illustrated, the external gate voltage control signal Sag maintains a logic-low state during an image display period 1P, and a logic-high state for a predetermined period of time during a vertical blanking period 1V.

The operation of the display device of FIG. 5 is as follows. First, a vertical synchronization start signal STV is applied just before an image display period 1P starts. Therefore, the first stage 210-1 operates at the same time the image display period 1P starts. The first stage 210-1 then outputs a gate turn-on voltage Von and supplies the gate turn-on voltage Von to the first gate line G1 through the first logic gate 220-1. The plurality of thin film transistors T that are connected to the first gate line G1 are then turned on, and the first data signal DS1 that is concurrently applied to the plurality of data lines D1 to Dm is supplied to the pixel capacitors Clc and the storage capacitors Cst associated with the first gate line.

Thereafter, the second to n-th stages 210-2 to 210-n operate sequentially in response to the respective outputs of the preceding first to (n-1)-th stages 210-1 to 210-n-1 and sequentially output a gate turn-on voltage Von. Further, the second to n-th logic gates 220-2 to 220-n that are connected to respective ones of the second to n-th stages 210-2 to 210-n then sequentially supply the gate turn-on voltage Von to respective ones of the second to n-th gate lines G2 to Gn. As described above, since a logic low level signal is applied to the first to the n-th logic gates 220-1 to 220-n that are respectively connected to the first to n-th stages 210-1 to 210-n, the respective outputs of the first to n-th stages 210-1 to 210-n become the respective outputs of the first to n-th logic gates 220-1 to 220-n during the image display period 1P. The operation of each of the stages 210-1 to 210-n is terminated by the commencement of the output of the next stage. To this end, a separate dummy stage (not illustrated) may be provided as the next stage after the final n-th stage 210-n. Further, it is preferable that the stages whose operation has stopped output a gate turn-off voltage Voff in a logic low state.

Then, as described above, when the vertical blanking period V1 starts, the external gate voltage control signal Sag becomes a logic high state, as described above. Therefore, output of the first to n-th logic gates 220-1 to 220-n becomes a gate turn-on voltage Von in a logic high state. Accordingly, the gate turn-on voltage Von is simultaneously applied to the first to n-th logic gates 220-1 to 220-n connected to the first to n-th gate lines G1 to Gn, such that all of the thin film transistors T in the LCD panel 100 are turned on simultaneously. In this way, the dummy data signal DSd is applied through the data lines D1-Dm to all of the pixel capacitors Clc and the storage capacitors Cst of the LCD panel 100, thereby eliminating any residual charges in the storage capacitors Cst.

As described above, vertical blanking periods exist between the image display periods during which images are displayed, the gate turn-on voltage is applied to all of the gate lines during the vertical blanking periods, and the dummy data signal for discharging the storage capacitors is applied so as to forcibly discharge any residual charges in the pixel storage capacitors, thereby preventing the occurrence of any residual images in the display.

As those of skill in this art will by now appreciate, many modifications, substitutions and variations can be made in and to the materials, methods and configurations of the LCDs and the methods for driving them of the present invention without departing from the spirit and scope thereof. In light of this, the scope of this invention should not be limited to that of the particular embodiments illustrated and described herein, as they are only by way of examples thereof, but instead, should be fully commensurate with that of the claims appended hereafter and their functional equivalents.

What is claimed is:

1. A method for driving a display device, the method comprising:
sequentially applying a gate turn-on voltage to respective ones of a plurality of gate lines of the device during successive image display periods thereof;
applying a respective one of a plurality of successive data signals, each corresponding to a respective one of the gate lines, to a plurality of data lines of the device while the gate turn-on voltage is being applied to the corresponding gate line;
applying the gate turn-on voltage to the plurality of gate lines of the device simultaneously during successive vertical blanking periods of the device that alternate with the image display periods thereof; and,
applying a dummy data signal to the data lines of the device while the turn-on voltage is being applied to respective ones of the gate lines thereof.

2. The method of claim 1, wherein each of the vertical blanking periods is longer than a period during which the gate turn-on voltage is applied to one gate line, and shorter than the image display period.

3. The method of claim 1, wherein the image display periods occur at a rate of 24 to 120 periods per second.

4. The method of claim 1, wherein the plurality of data signals are inversely driven.

5. The method of claim 1, wherein the number of the gate lines of the device is odd, and wherein an odd-number of the dummy data signals are applied to the data lines during each of the vertical blanking periods.

6. The method of claim 1, wherein the number of gate lines of the device is an even number, and wherein an even-number of the dummy data signals are applied to the data lines during each of the vertical blanking periods.

7. The method of claim 1, wherein a signal corresponding to one of a maximum or a minimum pixel grayscale value is used as the dummy data signal.

8. The method of claim 1, wherein the gate turn-on voltage is simultaneously applied to the plurality of gate lines of the device during each of the vertical blanking periods.

9. A display device, comprising:
an LCD panel that includes a plurality of gate lines and a plurality of data lines;
a gate driver connected to the plurality of gate lines and selectably operative to sequentially apply a gate turn-on voltage to respective ones of the gate lines or to simultaneously apply the gate turn-on voltage to the plurality of gate lines; and,
a data driver connected to the plurality of data lines and selectably operative to apply a respective one of a plurality of successive data signals, each corresponding to a respective one of the gate lines, to the data lines of the device while the gate turn-on voltage is being applied to the corresponding gate line, or to supply a dummy data signal to all of the data lines of the device while the turn-on voltage is being applied to all of the gate lines thereof.

10. The display device of claim 9, wherein the gate driver includes:
a plurality of stages that sequentially supply the gate turn-on voltage to respective ones of the plurality of gate lines; and,
a discharge controller disposed between the plurality of stages and the plurality of gate lines and operative to supply the gate turn-on voltage to respective ones of the plurality of gate lines in response to an external control signal.

11. The display device of claim 10, wherein the discharge controller comprises a plurality of OR gates or a plurality of exclusive OR gates respectively connected to corresponding ones of the gate lines.

12. The display device of claim 9, wherein:
the LCD panel further includes respective pluralities of thin film transistors, pixel capacitors and storage capacitors respectively disposed at intersections of the gate lines and the data lines; and,
one electrode terminal of each of an associated pair of the pixel and storage capacitors is connected to an associated one of the thin film transistors, and the other electrode terminals thereof are connected to a common power supply.
